(19) United States
(12) Patent Application Publication
(10) Pub. No.: US 2026/0310117 A1
(43) Pub. Date: Oct. 8, 2026

(54) IMAGE FORMING APPARATUS

(71) Applicant: CANON KABUSHIKI KAISHA, Tokyo (JP)

(72) Inventors: Akihisa Matsukawa, Tokyo (JP); Hiroki Tanaka, Kanagawa (JP); Kazunari Hagiwara, Kanagawa (JP); Tsuguhiro Yoshida, Kanagawa (JP); Hikaru Osada, Kanagawa (JP)

(21) Appl. No.: 19/552,128

(22) Filed: Feb. 27, 2026

(30) Foreign Application Priority Data
Apr. 3, 2025 (JP) 2025-061928

(51) Int. Cl. G03G 15/08; G03G 15/00; G03G 15/01

(52) U.S. Cl. CPC G03G 15/0844; G03G 15/0865; G03G 15/0889; G03G 15/50; G03G 15/0121; G03G 15/0189

(57) ABSTRACT

There is used an image forming apparatus including: an image carrier; a developing unit including a developing container, a stirring member, a developer carrier, and a supply member; a replenishment unit disposed above the developing unit; a replenishment control member configured to control replenishment of a developer; and a control unit, in which the control unit executes a refresh mode including a discharge operation of discharging the developer in the developing container to the image carrier and a replenishment operation of replenishing the developing container with the developer from the replenishment container, the control unit starts the replenishment operation before end of the discharge operation, and in at least a part of a section in the refresh mode, the control unit sets a rotating speed of the stirring member to be slower than that during image formation or stops the stirring member.

### BACKGROUND

### Field of the Technology

The present disclosure relates to an image forming apparatus.

### Description of the Related Art

An image forming apparatus includes a developing device that stores toner. Recently, with increased awareness of environmental protection, even for a developing device that is disposable in the related art, the necessity for additionally replenishing toner to realize long lifetime has increased. In general, when the toner is additionally replenished, a remaining toner amount in the developing device is detected in advance using a remaining amount detection sensor, and when the remaining amount is small, an additional replenishment operation of toner from a replaceable toner cartridge connected to the developing device is executed.

Toner used in the image forming apparatus is formed of powder having a certain degree of particle size distribution. Therefore, the toner in the developing device may include toner that is easily developed and toner that is difficult to be developed. Further, in a toner recycling system (cleanerless configuration) or the like that returns waste toner to the developing device to reuse the toner, toner that is not likely to be consumed returns to the developing device again without being cleaned. Therefore, the above-described phenomenon tends to occur.

Japanese Patent No. 5118881 discloses a configuration for dealing with a problem caused by a change in toner properties during toner consumption. Japanese Patent No. 5118881 discloses a configuration where, in order to refresh toner in a developing device during toner cartridge replacement, the toner is discharged to a waste toner container or the like through a photosensitive drum in a state where the amount of toner in the developing device is small. In a state where the amount of toner in the developing device is small, a ratio of toner that is difficult to be developed (large particle size toner or spent toner that cannot retain charge) increases. Therefore, the toner that is difficult to be developed can be efficiently discharged to the waste toner container or the like.

However, in the configuration disclosed in Japanese Patent No. 5118881 where the toner is discharged through the photosensitive drum, there are the following problems. First, since the toner is configured to be discharged due to a solid image in a state where the amount of toner in the developing device is small, the toner cannot be efficiently discharged and may require a long time. In addition, during the toner refresh operation, new toner needs to be replenished after executing the toner discharge operation in the developing device. Therefore, a long downtime is likely to occur.

### SUMMARY

The present disclosure has been made in consideration of the above-described problems. The present disclosure is directed to provide a technique for efficiently refreshing toner remaining in a developing device of an image forming apparatus.

The present disclosure provides an image forming apparatus capable of executing an image forming operation to form an image on a recording material, the image forming apparatus comprising:
an image carrier having a surface on which an electrostatic latent image is formed;
a developing unit including:
   a developing container configured to store developer,
   a rotatable stirring member disposed in the developing container and configured to stir the developer, and
   a developer carrier configured to supply the developer in the developing container to the electrostatic latent image to form an image;
a replenishment unit disposed above the developing unit in a gravity direction, the replenishment unit including a replenishment container configured to store the developer and communicate with the developing container through a replenishment port; and
a control unit configured to control rotation of the stirring member,
wherein the control unit is configured to:
(i) control execution of a refresh mode including:
   a discharge operation to discharge the developer in the developing container to the image carrier, and
   a replenishment operation to replenish the developing container with the developer from the replenishment container;
(ii) when executing the refresh mode, control starting of the replenishment operation before the discharge operation ends; and
(iii) after starting the refresh mode, in at least a part of a section until the refresh mode ends, control the stirring member such that a rotating speed of the stirring member is slower than a rotating speed during the image forming operation, or such that the stirring member is stopped.

The present disclosure also provides an image forming apparatus capable of executing an image forming operation to form an image on a recording material, the image forming apparatus comprising:
an image carrier having a surface on which an electrostatic latent image is formed;
a developing unit including:
   a developing container configured to store developer,
   a rotatable stirring member disposed in the developing container and configured to stir the developer, and
   a developer carrier configured to supply the developer in the developing container to the electrostatic latent image to form an image;
a replenishment unit disposed above the developing unit in a gravity direction, the replenishment unit including a replenishment container configured to store the developer and communicate with the developing container through a replenishment port; and
a control unit configured to control the stirring member, wherein the control unit is configured to:
(i) control execution of a refresh mode including:
   a discharge operation to discharge the developer in the developing container to the image carrier, and
   a replenishment operation to replenish the developing container with the developer from the replenishment container;
(ii) when executing the refresh mode, control starting of the replenishment operation before the discharge operation ends; and
(iii) after starting the refresh mode, in at least a part of a section until the refresh mode ends, control discharge of the developer such that the stirring member in the developing container does not come into contact with the developer.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a cross-section of an image forming apparatus of Example.

FIG. 2 is a detailed cross-sectional view of a process cartridge and a toner cartridge according to Example.

FIG. 3A is a top view illustrating a remaining toner amount detection unit of Example.

FIG. 3B is a diagram illustrating remaining toner amount detection of Example.

FIG. 3C is a diagram illustrating a remaining toner amount and a light amount of Example.

FIG. 4 is a control block diagram of Example 1.

FIG. 5 is a flowchart of Example 1.

FIGS. 6A to 6C are diagrams illustrating remaining toner amount transition and timing charts of Example 1 and Comparative Example 1.

FIGS. 7A to 7C are schematic diagrams illustrating toner circulation of Example 1.

FIGS. 8A to 8D are schematic diagrams illustrating toner circulation of Comparative Example 1.

FIGS. 9A to 9C are schematic diagrams illustrating toner circulation of Comparative Example 2.

FIGS. 10A to 10C are schematic diagrams illustrating toner circulation of Example 2.

FIG. 11 is a flowchart of Example 2.

FIGS. 12A to 12C are diagrams illustrating remaining toner amount transition and timing charts of Example 2.

FIGS. 13A to 13C are diagrams illustrating a replenishment port and a toner discharge position of Example 3.

### DESCRIPTION OF THE EMBODIMENTS

Hereinafter, examples of the present disclosure will be described in detail with reference to the drawings. However, the dimensions, materials, shapes, relative arrangements, and the like of the components described in the following examples should be appropriately changed according to the configuration of the apparatus to which the present disclosure is applied and various conditions. Therefore, the scope of the present disclosure is not limited unless otherwise specified. Although a plurality of features are described in the examples, not all of the plurality of features are necessarily essential to the disclosure, and the plurality of features may be arbitrarily combined.

### Example 1

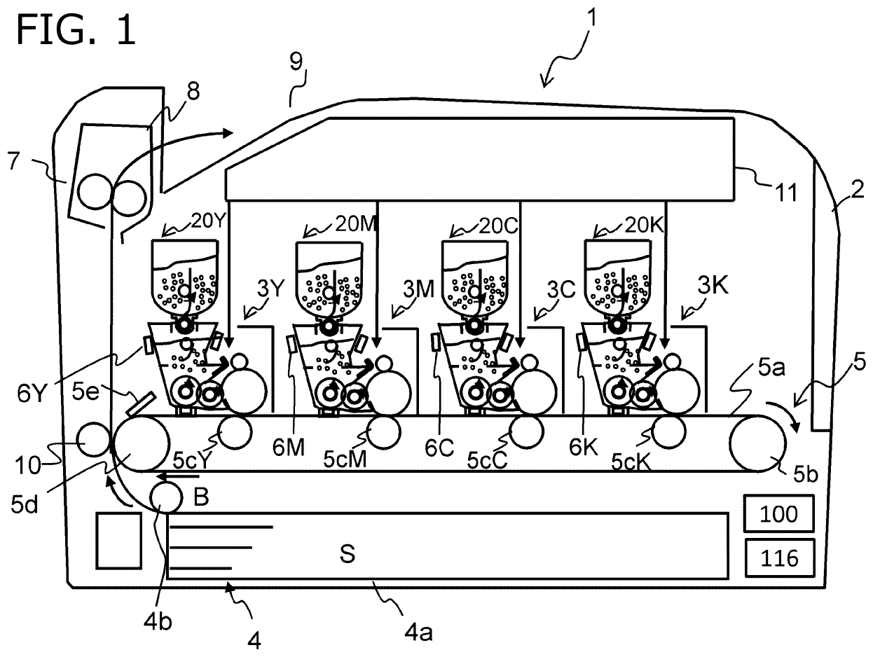

Hereinafter, Example 1 will be described using FIG. 1. An image forming apparatus in Example 1 includes four process cartridges 3 (3Y, 3M, 3C, 3K) and toner replenishment units 20. The number of the process cartridges 3 attached to the image forming apparatus is not limited to this example. The number of the process cartridges 3 is appropriately set as necessary.

In the following examples, a laser beam printer is described as one aspect of the image forming apparatus.

### Schematic Configuration of Image Forming Apparatus

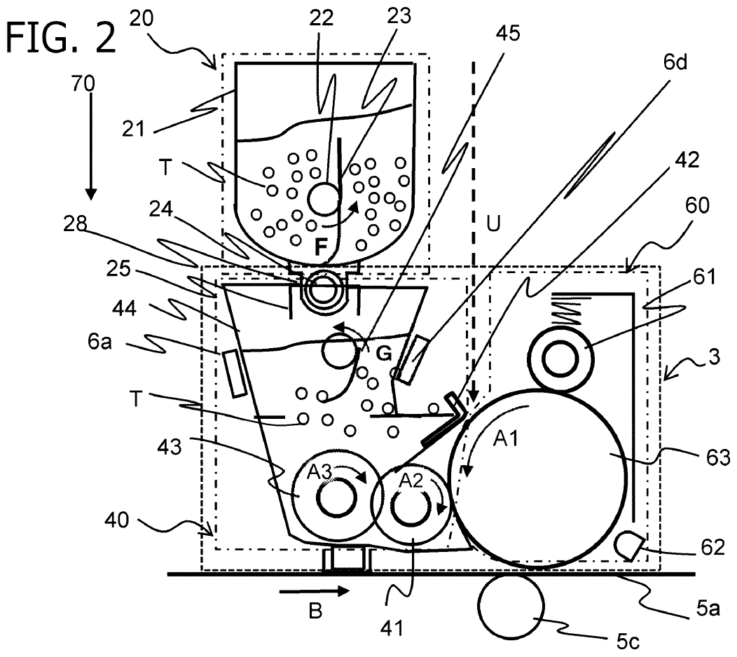

FIG. 1 is a schematic cross-sectional view of an image forming apparatus 1, process cartridges 3, and toner replenishment units 20 (toner cartridges) in Example 1. In addition, FIG. 2 is an enlarged cross-sectional view illustrating a portion of the process cartridge 3 and the toner replenishment unit 20. In the present disclosure, an upward direction of the drawing is upward direction of gravity.

The image forming apparatus 1 is a full-color (four-color) laser printer that forms a color image on a recording medium S using an electrophotographic process. The image forming apparatus 1 is a process cartridge type, and the process cartridge 3 is detachably attached to the image forming apparatus 1 through a front door 2.

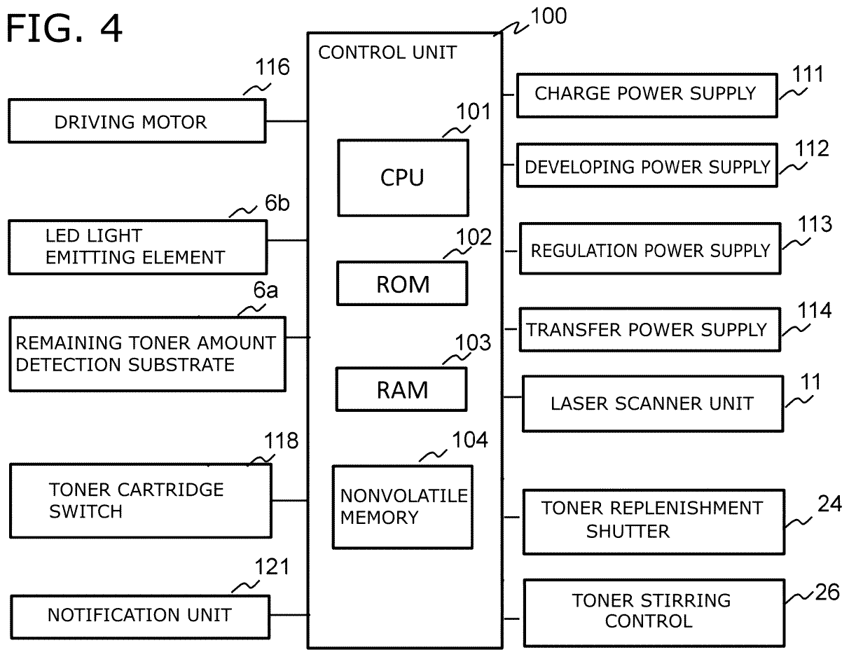

In the image forming apparatus 1, the first to fourth process cartridges 3 (3Y, 3M, 3C, 3K) are disposed in a substantially horizontal direction. The first to fourth process cartridges 3 (3Y, 3M, 3C, 3K) have the same electrophotographic process mechanism and contain developers (hereinafter, referred to as toner) of different colors. A rotation driving force is transmitted from a driving output unit (driving motor 116 or the like in FIG. 4) of the image forming apparatus 1 to the first to fourth process cartridges 3 (3Y, 3M, 3C, 3K). Hereinafter, unless it is particularly necessary to distinguish them, the process cartridges 3 will be simply referred to as the process cartridge 3 by omitting the subscripts (Y, M, C, K) representing the kinds of colors. In addition, unless it is particularly necessary to distinguish between members other than the process cartridges 3, the subscripts will be omitted.

In addition, voltages are supplied to the process cartridges 3 from various power supply units of the image forming apparatus 1. As illustrated in FIG. 4, the voltages include a charge voltage supplied from a charge power supply 111 to a charge roller 61, a developing voltage supplied from a developing power supply 112 to a developing roller 41, and a regulation voltage supplied from a regulation power supply 113 to a developing blade 42. A transfer voltage is supplied from a transfer power supply 114 of the image forming apparatus 1 to a primary transfer roller 5c and a secondary transfer roller 10.

As illustrated in FIG. 2, the process cartridge 3 according to the present example includes a photosensitive drum 63 that is an image carrier, and a drum unit 60 that includes a charge unit as a process unit acting on the photosensitive drum 63. Here, the drum unit 60 may include not only a charge unit but also a cleaning unit as the process unit.

In addition, the process cartridge 3 includes a developing unit 40 that develops an electrostatic latent image on the photosensitive drum 63.

Further, first to fourth toner replenishment units 20 (20Y, 20M, 20C, 20K) are connected to the first to fourth process cartridges 3 (3Y, 3M, 3C, 3K), respectively. The drum unit 60, the developing unit 40, and the toner replenishment unit 20 are connected to each other. A more detailed configuration of the process cartridge 3 will be described below.

The first toner replenishment unit 20Y stores yellow (Y) toner T. A developing container 44 of the first process cartridge 3Y stores the yellow (Y) toner T. The first process cartridge 3Y forms a yellow toner image on a surface of the photosensitive drum 63. Hereinafter, likewise, the second process cartridge 3M to the fourth process cartridge 3K and the second toner replenishment unit 20M to the fourth toner replenishment unit 20K store the toners T for forming the corresponding color images, respectively.

In the vicinity of the developing container 44, remaining toner amount detection units 6 (6Y to 6K), each including a remaining toner amount detection substrate 6a, are disposed. The remaining toner amount detection unit 6 estimates a toner level to read a remaining toner amount in the developing container 44. The detailed operation will be described below.

A laser scanner unit 11 as an exposure unit is provided above the first to fourth process cartridges 3 (3Y, 3M, 3C, 3K). The laser scanner unit 11 outputs laser light U corresponding to image information. The laser light U scans and exposes the surface of the photosensitive drum 63. The image information may be received from an external host device, and when the image forming apparatus 1 includes an image reading unit, read image information may be used.

An intermediate transfer unit 5 as a transfer member is provided below the first to fourth process cartridges 3 (3Y, 3M, 3C, 3K). The intermediate transfer unit 5 includes a driving roller 5d and a tension roller 5b, over which a flexible intermediate transfer belt 5a is stretched.

A lower surface of the photosensitive drum 63 of each of the first to fourth process cartridges 3 (3Y, 3M, 3C, 3K) is in contact with an upper surface of the intermediate transfer belt 5a. The contact portion is a primary transfer portion. Inside the intermediate transfer belt 5a, the primary transfer rollers 5c (5cY, 5cM, 5cC, 5cK) are provided facing the photosensitive drum 63.

The secondary transfer roller 10 abuts against the driving roller 5d with the intermediate transfer belt 5a interposed therebetween. The contact portion between the intermediate transfer belt 5a and the secondary transfer roller 10 is a secondary transfer portion. After secondary transfer, the belt surface is cleaned by a belt cleaning member 5e, and waste toner remaining after transfer is recovered.

A feeding unit 4 is provided below the intermediate transfer unit 5. The feeding unit 4 includes a paper feeding tray 4a on which the recording medium S (recording material) is placed and stored and a paper feeding roller 4b.

A fixing device 7 and a paper discharge device 8 are provided on an upper left side in a main body of the image forming apparatus 1 in FIG. 1. An upper surface of the image forming apparatus 1 functions as a paper discharge tray 9. The toner image is fixed to the recording medium S, to which the toner image of each color has been transferred, by a fixing unit provided in the fixing device 7, and the recording medium S is discharged to the paper discharge tray 9.

A control unit 100 transmits and receives information to and from the components of the image forming apparatus 1 to control the operation. As a driving source, the driving motor 116 transmits power to a movable component such as a rotation element through a driving path such as a belt or a gear.

### Image Forming Operation

An operation for forming a full-color image is as follows. The photosensitive drum 63 of each of the first to fourth process cartridges 3 (3Y, 3M, 3C, 3K) is driven to rotate at a predetermined speed (arrow A1 direction in FIG. 2). In the image forming apparatus 1 according to the present example, when A4-size sheets of paper are continuously fed, a print speed is 36 sheets per minute, and a peripheral surface of the photosensitive drum 63 rotates at 180 mm/sec.

The intermediate transfer belt 5a is also driven to rotate in the same direction as the photosensitive drum 63 (arrow B direction in FIGS. 1 and 2) at a speed corresponding to the speed of the photosensitive drum 63.

The charge roller 61 comes into contact with the photosensitive drum 63 with a predetermined pressure contact force and applies a desired charge voltage thereto such that the surface of the photosensitive drum 63 is uniformly charged to a predetermined potential.

In addition, the laser scanner unit 11 is also driven. In synchronization with the driving of the laser scanner unit 11, the charge roller 61 in each of the process cartridges 3 uniformly charges the surface of the photosensitive drum 63 to a predetermined polarity and potential. The laser scanner unit 11 scans and exposes the surface of each of the photosensitive drums 63 with the laser light U according to an image signal of each color. As a result, an electrostatic latent image corresponding to the image signal of the corresponding color is formed on the surface of each of the photosensitive drums 63. The formed electrostatic latent image is developed by the developing roller 41 that is driven to rotate at a predetermined speed.

### Detailed Operation of Process Cartridge

Next, the process cartridge 3 will be described in detail. The process cartridge 3, which is illustrated in detail in FIG. 2, includes the developing unit 40. The developing unit 40 includes the developing roller 41 as a developer carrier that carries the developer, the developing container 44 that is a container of the developing unit 40, and a supply roller 43 as a supply member that can supply the developer to the developing roller 41. The developing roller 41 and the supply roller 43 are rotatably supported by the developing container 44.

In addition, the developing roller 41 is disposed in an opening of the developing container 44 to be rotatable in an arrow A2 direction and to face the photosensitive drum 63. The supply roller 43 is supported to be rotatable in an A3 direction so as to abut against the developing roller 41. The toner T as the developer stored in the developing container 44 is applied to the surface of the developing roller 41 by the supply roller 43.

The toner replenishment unit 20 is attachable to the process cartridge 3 and includes a toner container 21 that stores the toner T. The toner replenishment unit 20 is disposed above the developing container 44 in the gravity direction. The toner replenishment unit 20 includes a replenishment opening 28 connected to a developing opening 25 of the developing container 44. The replenishment opening 28 has a toner replenishment shutter 24. The supply roller 43 is disposed below the developing opening 25 in a vertical direction. The toner replenishment unit 20 is replaceable by a user.

The toner replenishment shutter 24 disposed at a connection portion between the toner replenishment unit 20 and the developing container 44 is opened and closed at any timing under control of the control unit 100 to establish or block communication between the toner replenishment unit 20 and the developing container 44.

In the toner replenishment unit 20, a stirring shaft 22 for toner replenishment and a stirring sheet 23 for toner replenishment are disposed. The stirring sheet 23 for toner replenishment rotates in a counterclockwise direction in the drawing (arrow F). By the rotation of the stirring sheet 23 for toner replenishment, the toner T in the toner replenishment unit 20 is circulated and conveyed from the toner replenishment unit 20 to the developing container 44.

In the present example, the stirring shaft 22 for toner replenishment is configured to constantly rotate when the process cartridge 3 is being driven, and the replenishment operation of the toner T is controlled by opening and closing the toner replenishment shutter 24. Note that the rotation of the stirring shaft 22 for toner replenishment may be set according to control of the control unit 100.

The control unit 100 of the image forming apparatus 1 illustrated in FIG. 4 receives a signal from the remaining toner amount detection substrate 6a and executes the toner replenishment operation such that the remaining toner amount in the developing container 44 remains constant. That is, the control unit 100 executes the replenishment operation of the toner T by controlling the opening and closing of the toner replenishment shutter 24 and the rotation of the stirring sheet 23 for toner replenishment. In the present configuration, the stirring sheet 23 for toner replenishment is configured to adjust a rotating speed according to the control of the control unit 100, and a replenishment speed can be changed depending on the rotating speed of the stirring sheet 23 for toner replenishment.

In the present example, the replenishment speed can be changed depending on the rotating speed of the stirring sheet 23 for toner replenishment. However, the method of changing the replenishment speed is not limited to the present configuration. For example, the method may include a configuration that changes the degree of opening of the toner replenishment shutter 24, or a configuration that changes a flow rate of air in a method of replenishing the toner T from a toner replenishment container together with air using a pump. A replenishment control member that controls the replenishment of the developing container 44 with the toner T from the toner replenishment unit 20 may have any configuration as long as the replenishment control member can control start and stop of the replenishment to control the replenishment speed. For example, the toner replenishment unit 20 may be regarded as the replenishment control member. Alternatively, the toner replenishment unit 20 combined with functions of the control unit 100 that control the start, stop, and replenishment speed of toner replenishment may be regarded as the replenishment control member.

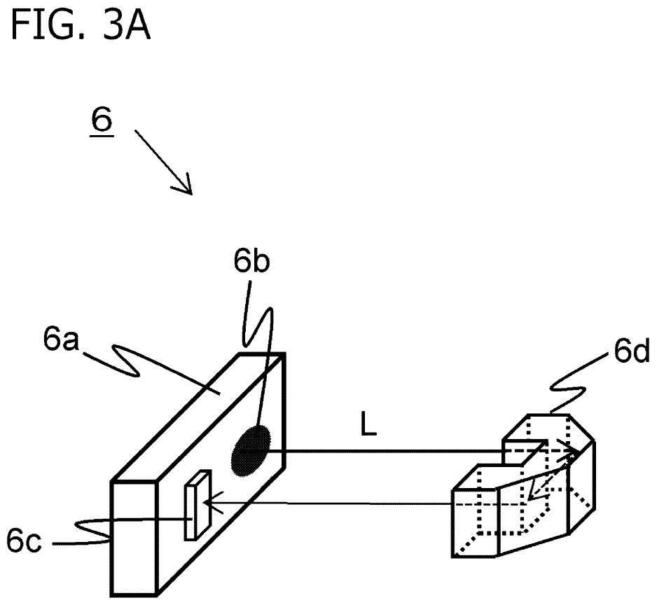

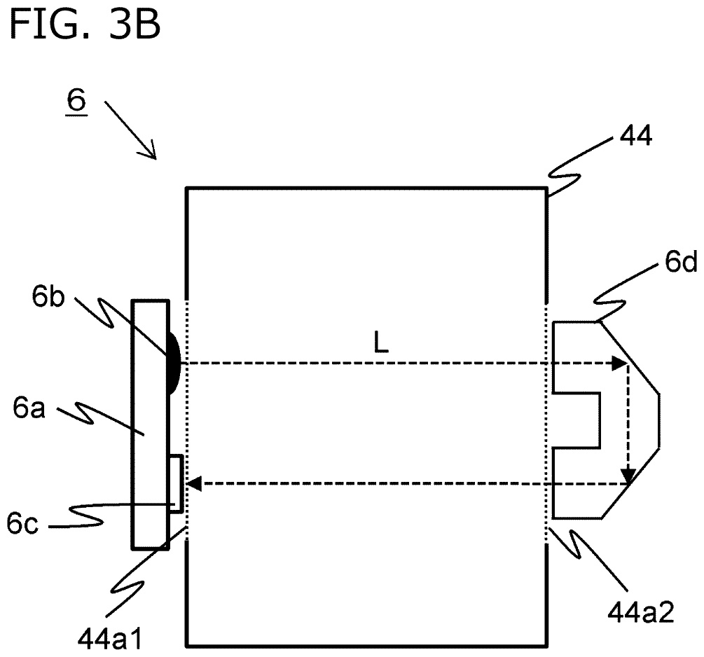

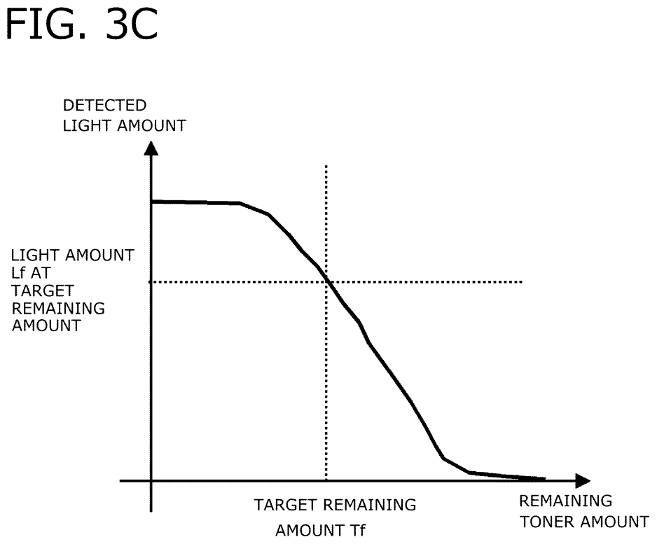

FIG. 3A is a perspective view illustrating an outline of the remaining toner amount detection unit 6. FIG. 3B is a schematic diagram illustrating a positional relationship among the remaining toner amount detection substrate 6a, a light reflection member 6d, the developing container 44, and light L in the remaining toner amount detection unit 6 when viewed from above the developing unit 40 in the gravity direction. A lower side of FIG. 3B is a front side of the schematic diagram of the process cartridge 3 in FIG. 2.

The remaining toner amount detection substrate 6a is disposed in the vicinity of the developing container 44. On the remaining toner amount detection substrate 6a, an LED light emitting element 6b of which emission is controlled by the control unit 100 at any timing and a light amount detection sensor 6c are disposed. In the vicinity of a position facing the remaining toner amount detection substrate 6a with the developing container 44 interposed therebetween, the light reflection member 6d is fixed and disposed.

Light L having directivity is emitted from the LED light emitting element 6b of the remaining toner amount detection substrate 6a in a direction toward the light reflection member 6d. On a wall surface of the developing container 44, a region facing the remaining toner amount detection substrate 6a is formed of a transparent window 44a1, and a region facing the light reflection member 6d is formed of a transparent window 44a2. As a result, reflection and absorption of the light L on an optical path of the light L emitted from the LED light emitting element 6b are suppressed.

The emitted light L crosses the inside of the developing container 44, is reflected by the light reflection member 6d, and is incident on the light amount detection sensor 6c of the remaining toner amount detection substrate 6a. The light amount detection sensor 6c reads the light amount of the reflected light L. The detected light amount changes significantly depending on the toner level in the developing container 44. When the proportion of the optical path blocked by the toner level is high, the detected light amount decreases, and when the proportion of the optical path blocked by the toner level is low, the detected light amount increases. By reading the light amount, the control unit 100 can estimate the toner level, that is, the remaining toner amount in the developing container 44.

FIG. 3C is a graph illustrating a relationship between the remaining toner amount (toner level) in the developing container 44 in the horizontal axis and the light amount detected by the light amount detection sensor 6c in a vertical axis. When a light amount Lf is detected by the remaining toner amount detection substrate 6a and the light reflection member 6d, it is assumed that the remaining toner amount in the developing container 44 is a target remaining amount Tf.

By reading a signal from the remaining toner amount detection substrate 6a and driving the toner replenishment shutter 24, the control unit 100 according to the present example controls such that an average remaining amount of the toner T in the developing container 44 is maintained at about 40 g. To that end, based on the signal from the remaining toner amount detection substrate 6a, the control unit 100 starts the replenishment operation when the toner amount in the developing container 44 reaches 37 g (D-LOW), and executes the replenishment operation until the detected toner amount in the developing container 44 is 43 g (D-FULL). As a result, the average toner amount in the developing container 44 is maintained at 40 g.

In the present example, a remaining amount detection unit using light is used as a unit that estimates the remaining toner amount in the developing container 44, but the unit that estimates the remaining toner amount is not limited thereto. For example, the current remaining toner amount may be calculated by estimating the used toner amount from printed image information and subtracting the estimated used toner amount from the toner amount that was initially stored.

When the toner amount in the toner replenishment unit 20 is small such that the toner replenishment unit 20 approaches a replacement timing, the image forming apparatus 1 notifies the user of TONER-LOW (T-LOW). The user notification is executed, for example, by a notification unit 121 including a display device or a voice output device. Further, when the toner amount in the toner replenishment unit 20 is small such that the toner replenishment is impossible, the image forming apparatus 1 notifies the user of TONER-OUT (T-OUT) and requests the replacement of the toner replenishment unit 20.

In the present example, the control unit 100 estimates the residual toner amount in the toner replenishment unit 20 based on a relationship between toner replenishment by opening and closing of the toner replenishment shutter 24 and rotation of the stirring shaft 22 for toner replenishment, and an amount of increase in the toner amount in the developing container 44, and notifies TONER-LOW and TONER-OUT. That is, when the amount of increase in the toner amount in the developing container 44 with respect to the number of rotations of the stirring shaft 22 for toner replenishment is less than a predetermined threshold, the control unit 100 determines TONER-LOW (T-LOW). Further, when the toner amount in the developing container 44 does not increase even after the toner replenishment operation, the control unit 100 determines TONER-OUT.

In addition, when the remaining toner amount in the developing container 44 is desired to be widely detected, for example, the above-described configuration may be disposed at two positions in a longitudinal direction in the gravity direction such that the light amount of the light L changes depending on a wider change in toner level.

The method of detecting the remaining toner amount of the toner replenishment unit 20 is not limited to this example, and the user may estimate the remaining toner amount from the image information printed by the user. In addition, a remaining toner amount detection unit may be mounted on the toner replenishment unit 20.

The developing unit 40 according to the present example uses a contact development method as a developing method. That is, a toner layer carried on the developing roller 41 comes into contact with the photosensitive drum 63 in a developing portion (developing region) where the photosensitive drum 63 and the developing roller 41 face each other. In addition, the developing voltage is applied from the developing power supply 112 to the developing roller 41. Under a condition where the developing voltage is applied, the toner T carried on the developing roller 41 is transferred to the surface of the photosensitive drum 63 to develop the toner image in accordance with the electrostatic latent image on the surface of the photosensitive drum 63.

In the present example, the developing voltage is −300 V. In the present example, a reversal development method is adopted. That is, after charging the surface of the photosensitive drum 63 in a charge step, the surface of the photosensitive drum 63 is exposed in an exposure step. As a result, an exposed region where the charge amount is attenuated is formed on the photosensitive drum surface, and the toner T from the developing roller 41 attaches to the exposed region to form the toner image. The toner image is transferred from the photosensitive drum 63 of each color to the intermediate transfer belt 5a. After transferring the toner image from the photosensitive drum 63 to the intermediate transfer belt 5a, the potential of the photosensitive drum 63 surface is erased by a pre-exposure portion 62 (refer to FIG. 2) and made uniform. The photosensitive drum surface is charged again by the charge roller 61.

In the present example, toner T having a particle size of 7.0 μm and a normal charge polarity of negative is used. As the toner T, for example, polymerized toner generated by a polymerization method is adopted. The toner T does not contain a magnetic component, and is a so-called non-magnetic single-component developer in which the toner T is mainly carried on the developing roller 41 by an intermolecular force or electrostatic force (mirror image force).

Toner particles include a plurality of waxes for adjusting melting characteristics of the toner T during a fixing process and an adhesion force between a printing medium and a fixing roller. Fine particles composed of silica particles having a particle size on the order of submicrons are added to the surfaces of the toner particles to adjust fluidity and chargeability of the toner T. In the present example, the toner T to which the fine particles are added is defined as a developer.

In the present example, although the non-magnetic single-component developer is used as an example, a single-component developer containing a magnetic component may be used. In addition, a two-component developer configured of the non-magnetic toner T and a magnetic carrier may be used as the developer. When the magnetic developer is used, for example, a cylindrical developing sleeve in which a magnet is disposed is used as the developer carrier.

A stirring member 45 as a stirrer is provided inside the developing container 44. The stirring member 45 is driven to rotate (arrow G) to stir the toner T in the developing container 44 and to convey the toner T toward the developing roller 41 and the supply roller 43. In addition, the stirring member 45 has a role of circulating the toner T not used for development but peeled off from the developing roller 41 in the developing container and making the toner T in the developing container uniform. In the present example, the driving of the stirring member 45 is configured to be operable independently of the developing roller 41.

In addition, the developing blade 42 that is formed of a stainless steel plate and regulates the amount of the toner T carried on the developing roller 41 is disposed in an opening of the developing container 44 in which the developing roller 41 is disposed. A voltage having an absolute value 200 V greater on the negative polarity side than the developing roller 41 is applied from the regulation power supply 113 to the developing blade 42. That is, a voltage 200 V greater in the normal polarity direction of the toner T is applied to the developing blade 42.

The developer supplied to the surface of the developing roller 41 passes through a portion facing the developing blade 42 as the developing roller 41 rotates and is uniformly formed into a thin layer. Concurrently, the developer is charged to negative polarity that is the normal polarity of the toner T by triboelectric charging with the developing blade 42 and by direct injection charging based on a potential difference between the developing blade 42 and the developing roller 41.

In the present example, a so-called cleanerless configuration is adopted in which transfer residual toner remaining on the photosensitive drum 63 without being transferred to the recording medium S is recovered to the developing unit 40 and reused. The transfer residual toner is reused in the following steps.

In the transfer residual toner, toner T charged to positive polarity, which is opposite to the normal polarity in the present example, and toner T charged to negative polarity but lacking a sufficient charge are mixed. During the charge step of the photosensitive drum 63 by the charge roller 61, these toners T are uniformly charged to negative polarity due to bias discharge to the negative polarity side of the charge roller 61.

The transfer residual toner charged to negative polarity reaches the developing portion along with the rotation of the photosensitive drum 63. Here, behavior of the transfer residual toner that has reached the developing portion will be described separately for an exposed portion and a non-exposed portion of the photosensitive drum 63. In the non-exposed portion of the photosensitive drum 63, that is, a dark potential portion, a surface potential of the photosensitive drum 63 is more negative than the developing voltage applied to the developing roller 41. Therefore, the transfer residual toner having a sufficient negative charge moves to the developing roller 41 by Coulomb force due to an electric field and is recovered into the developing container 44. Here, the dark potential portion of the photosensitive drum 63 is not limited to the non-exposed portion, and weak exposure may be performed as long as the surface potential of the photosensitive drum 63 is more negative than the developing voltage applied to the developing roller 41.

The toner T recovered in the developing container 44 is stirred with and dispersed in the toner T in the developing container 44 by the stirring member 45, and is carried on the developing roller 41 to be used again in the developing step.

On the other hand, in the exposed portion of the photosensitive drum 63, since the surface potential of the photosensitive drum 63 is smaller on the negative polarity side than the developing voltage applied to the developing roller 41, the transfer residual toner remains on the surface of the photosensitive drum 63 without being transferred from the photosensitive drum 63 to the developing roller 41 in the developing portion. The transfer residual toner remaining on the surface of the photosensitive drum 63 is carried on the photosensitive drum 63 together with other toners T transferred from the developing roller 41 to the exposed portion, moves to the transfer unit, and is transferred to the recording medium S in the transfer unit.

In the present example, the dark potential portion is set to −500 V, and the exposed potential portion is −50 V. As described above, the developing voltage is set to −300 V. A back contrast, which is a potential difference between the dark potential portion of the photosensitive drum 63 having passed through the abutment portion with the charge roller 61 and the developing voltage (surface potential of the developing roller 41), is Δ200 V. In addition, a developing contrast that is a potential difference between the exposed portion of the photosensitive drum 63 and the developing voltage (surface potential of the developing roller 41) is Δ250 V.

Through the above-described electrophotographic image forming process operation, a yellow toner image corresponding to a yellow component of the full-color image is formed on the photosensitive drum 63 of the first process cartridge 3Y. The toner image is primarily transferred to the intermediate transfer belt 5a.

Likewise, a magenta toner image corresponding to a magenta component of the full-color image is formed on the photosensitive drum 63 of the second process cartridge 3M. The toner image is primarily transferred to be layered on the yellow toner image that has been already transferred to the intermediate transfer belt 5a.

Likewise, a cyan toner image corresponding to a cyan component of the full-color image is formed on the photosensitive drum 63 of the third process cartridge 3C. The toner image is primarily transferred to be layered on the yellow and magenta toner images that have been already transferred to the intermediate transfer belt 5a.

Likewise, a black toner image corresponding to a black component of the full-color image is formed on the photosensitive drum 63 of the fourth process cartridge 3K. The toner image is primarily transferred to be layered on the yellow, magenta, and cyan toner images that have been already transferred to the intermediate transfer belt 5a. In this manner, full-color unfixed toner images of four colors including yellow, magenta, cyan, and black are formed on the intermediate transfer belt 5a.

On the other hand, the recording media S are separated and fed one by one at a predetermined control timing. The recording medium S is introduced into the secondary transfer portion that is an abutment portion between the secondary transfer roller 10 and the intermediate transfer belt 5a at the predetermined control timing. As a result, as the recording medium S is conveyed through the secondary transfer portion, the four-color superimposed toner images on the intermediate transfer belt 5a are collectively and sequentially transferred onto the surface of the recording medium S.

### Control Aspect

FIG. 4 is a schematic block diagram illustrating a control aspect of a main part of the image forming apparatus 1. The control unit 100 includes a CPU 101 as an arithmetic control unit that is a central element for executing arithmetic processing, a storage element such as a ROM 102, a RAM 103, or a nonvolatile memory 104 as a storage unit, an input/output unit (not illustrated) that controls transmission and reception of signals between various elements connected to the control unit 100, and the like. The RAM 103 stores a detection result of a sensor, an arithmetic result, and the like, and the ROM 102 stores a control program, a data table obtained in advance, and the like.

The control unit 100 is a controller that integrally controls the operation of the image forming apparatus 1. The control unit 100 executes a predetermined image forming sequence by controlling transmission and reception of various electrical information signals, a driving timing, and the like. Each unit of the image forming apparatus 1 is connected to the control unit 100. For example, in the relationship with the present example, the charge power supply 111, the developing power supply 112, the regulation power supply 113, the transfer power supply 114, the laser scanner unit 11, the toner replenishment shutter 24, a toner stirring control 26, the driving motor 116, the LED light emitting element 6b, the remaining toner amount detection substrate 6a, a toner cartridge switch 118, the notification unit 121, and the like are connected to the control unit 100.

### Replacement of Unit and Cartridge

In the present example, when the remaining toner amount is small, the toner replenishment unit 20 notifies the user of replacement with a new product. In addition, the developing unit 40 and the drum unit 60 are integrated into the process cartridge 3, and the process cartridge 3 is attachable to and detachable from the image forming apparatus 1.

The developing roller 41, the developing blade 42, the supply roller 43, the photosensitive drum 63, the charge roller 61, the toner T, and the like deteriorate with user use, and it becomes difficult to provide sufficient image quality from a certain usage amount. In the image forming apparatus 1 according to the present example, deterioration of the members and the toner T is predicted based on the number of rotations of the developing roller 41 and the photosensitive drum 63. When the predicted deterioration exceeds a certain threshold, the process cartridge 3 is determined to have reached the end of its lifetime, and the user is notified of replacement with a new one.

In the present example, when the user performs continuous printing of two sheets on average per print job, and when a total of 50,000 sheets have been printed using the process cartridge 3, the user is notified of information that the process cartridge 3 has reached the end of its lifetime and information regarding replacement with a new cartridge.

### Toner Refresh Mode

In a toner refresh mode, after replacing the toner replenishment unit 20 (toner cartridge) with a new product, a series of operations of discharging the deteriorated toner T remaining in the process cartridge 3 and replenishing the new toner T is executed. The discharged toner T is transferred from the photosensitive drum 63 to the intermediate transfer belt 5a, is cleaned by the belt cleaning member 5e, and is stored in a waste toner container (not illustrated). The detailed control will be described in a toner refresh operation below.

### Confirmation of Effect of Example

In the present example, evaluation is executed using the image forming apparatus 1 described above. Table 1 shows configurations of toner refresh modes in Examples 1 to 3 and Comparative Examples 1 to 3.

### Durability Evaluation Method

Test environment: temperature 23.5° C. and humidity 50%
The toner amount in the developing container 44 of the process cartridge 3 is controlled to be within a range from 43 g (D-FULL) to 37 g (D-LOW), and durability evaluation is performed using intermittent printing of two sheets with a two-second interval at a 2% print coverage rate on Vitality paper.

The unused toner replenishment unit 20 stores 60 g of the toner T. When the toner replenishment unit 20 is in TONER-OUT, the user who received the notification executes the replacement. Next, the control unit 100 continues the durability test after executing the toner refresh mode.

Regarding Comparative Example 3, the toner refresh mode is not performed. After the toner cartridge is in TONER-OUT, the toner cartridge is replaced with a new product, and the control unit 100 continues the durability test until the number of printed sheets reaches 18000. In table 1, “Overlap time” means Overlap time between discharge and refill. “Contact” means Contact between toner level and stirring member.

TABLE 1

| | State during toner refresh mode refill | | | Toner control amount (g) | |
|---|---|---|---|---|---|
| | Stirring | Overlap | | Discharge | Refill |
| | member | time | Contact | amount | amount |
| Example 1 | Stopped | Present | Contact | 20 | 26 |
| Example 2 | Rotating | Present | Non-contact | 15 | 25 |
| | | | Remaining toner | | |
| | | | amount 33 g | | |
| Example 3 | Rotating | Present | Non-contact | 17 | 27 |
| | | | Remaining toner | | |
| | | | amount 33 g | | |
| Comparative | Rotating | None | Contact | 20 | 26 |
| Example 1 | | | | | |
| Comparative | Rotating | Present | Contact | 20 | 26 |
| Example 2 | | | | | |

| | |
|---|---|
| Comparative | No refresh mode |
| Example 3 | |

Table 2 shows results and effects when the durability evaluation is performed in each of the configurations of Table 1. As a performance comparison, results of downtime, failure risk, and image quality when the number of printed sheets reaches 18,000 are shown. In addition, the time required for the toner refresh mode is shown. In addition, after the durability test, a density, toner fogging, an image quality of a halftone image, and an average toner particle size in the developing container were checked. In Table 2, “CE 1” to “CE 3” means “Comparative Example 1” to “Comparative Example 3”. “EPD=20” in “Refill time” means “End portion discharge=20”. “Particle size” means Particle size in developing container.

TABLE 2

| | | | | Toner refresh | | | Durability evaluation 18K | | | |
|---|---|---|---|---|---|---|---|---|---|---|
| | Performance comparison | | | mode time (sec) | | | (corresponding to three times of T-CRG) | | | |
| | | Failure | Image | Discharge | | | | | | Particle |
| | Downtime | risk | quality | time | Refill time | Total | Density | Fogging | Halftone | size |
| Example | ◯ | ◯ | ◯ | 120 | R1 = 120 | 120 | 1.35 | 1.50% | ◯ | 7.8 |
| 1 | Short | Low | Good | | | | | | | |
| Example | ◯ | ◯ | ◯ | 90 | R21 = 90, R22 = 20 | 110 | 1.32 | 1.50% | ◯ | 8 |
| 2 | Short | Low | Good | | | | | | | |
| Example | ◯ | ◯ | ⊚ | 110 | R21 = 90, R22 = 20 | 130 | 1.35 | 1% | ◯ | 7.7 |
| 3 | Short | Low | Very | | EPD = 20 | | | | | |
| | | | good | | | | | | | |
| CE 1 | X | X | Δ | 153 | 52 | 205 | 1.35 | 1.50% | Streak | 7.8 |
| | Long | High | Slightly | | | | | | | |
| | | | bad | | | | | | | |
| CE 2 | ◯ | ◯ | X | 120 | R1 = 120 | 120 | 1.2 | 4% | ◯ | 9 |
| | Short | Low | Bad | | | | | | | |
| CE 3 | — | — | X | — | — | — | 1.1 | 7% | Graininess | 10.2 |
| | | | Bad | | | | | | | |

Confirmation of the effects was executed as follows.
Fogging measurement: using a reflectometer (trade name: REFLECTOMETER MODEL TC-6DS, manufactured by Tokyo Denshoku Co., Ltd.), a whiteness index T1 of a portion on the printed recording medium S to which a Post-it note is not attached and a whiteness index T2 of a portion on the recording medium S to which a Post-it note is attached were measured, respectively. (T2−T1) was calculated as a fogging toner density (%) from the above results.
Density measurement: the measurement was performed using X-rite exact advance (manufactured by X-rite).
Measurement of average toner particle size: an average particle size of the toner T was measured using a high-precision particle size distribution analyzer “Coulter counter Multisizer 3” (registered trademark, manufactured by Beckman Coulter, Inc.) including a 100 μm aperture tube by resistive pulse sensing.

### Toner Refresh Mode Operation

The toner refresh mode that is the feature of the present example will be described using Example 1.

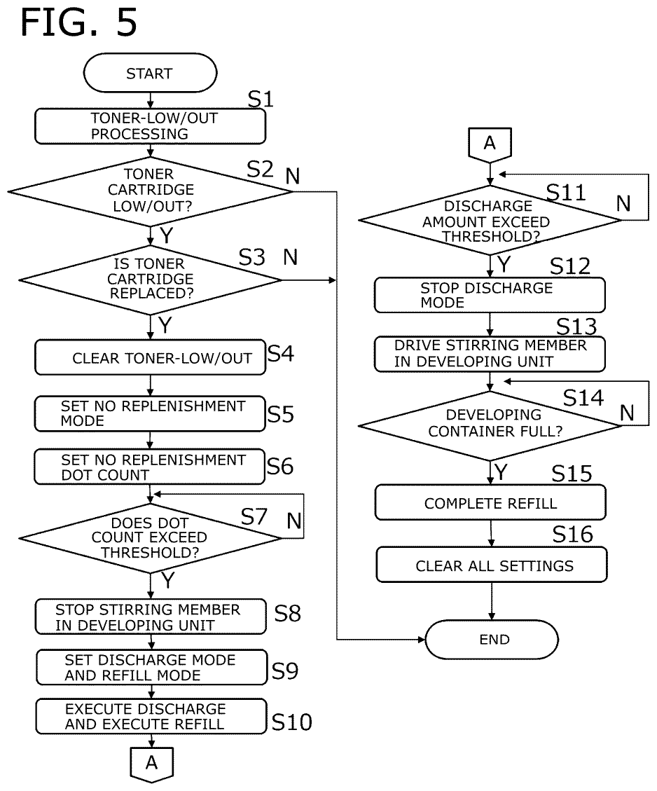

FIG. 5 is a flowchart illustrating a procedure of the toner refresh mode that is executed by the control unit 100. Hereinafter, the procedure of Example 1 will be described.

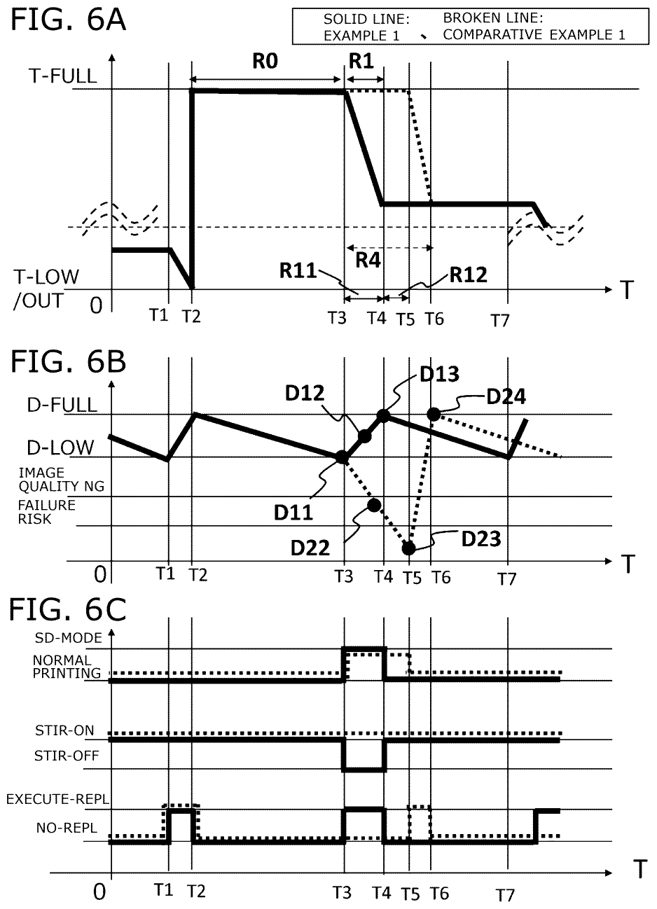

In addition, FIGS. 6A to 6C illustrate timing charts regarding the flow. That is, FIG. 6A illustrates transition of the remaining amount in the toner replenishment unit during the execution. FIG. 6B illustrates transition of the remaining amount in the developing container. For example, FIGS. 6A and 6B show that toner replenishment is performed between timings T1 and T2, and that the toner T in the toner replenishment unit moves into the developing device. As a result, at T2, the toner replenishment unit 20 is in TONER-OUT, and the developing container 44 is in D-FULL. In addition, FIG. 6C illustrates the timing chart of various operations. In each of the charts, the horizontal axis T represents an arbitrary time. In FIG. 6C, “SD-MODE” means “Solid Discharge Mode”. “STIR-ON” means “Stirring Driving ON”. “STIR-OFF” means “Stirring Driving Off”. “EXECUTE-REPL” means “Execute Replenishment”. “NO-REPL” means “No Replenishment”.

In FIGS. 6A to 6C, a solid line indicates a remaining toner amount change and a control timing of Example 1. A broken line indicates a case of Comparative Example 1.

Step S1: the control unit 100 executes TONER-LOW/OUT processing. Next, the control unit 100 detects a detection signal in the developing container 44 transmitted from the remaining toner amount detection substrate 6a. The timing of the present processing can be freely determined. For example, the processing can be performed regularly, in response to a user instruction, or during replacement of various cartridges.

Step S2: based on the detection signal of the remaining toner amount in the developing container transmitted from the remaining toner amount detection substrate 6a, the control unit 100 detects whether the remaining amount in the toner cartridge is small (T-LOW) or absent (T-OUT). When the remaining toner amount is not small or is present, the control unit 100 controls the toner refresh mode to end (S2: N).

Step S3: when the control unit 100 detects that the remaining toner amount is insufficient or absent (S2: Y), the control unit 100 detects whether replacement of the toner replenishment unit 20 has been performed based on the detection signal from the toner cartridge switch 118. When the replacement of the toner replenishment unit 20 is not performed (S3: N), the control unit 100 controls the toner refresh mode to end.

Step S4: when it is confirmed that replacement of the toner replenishment unit 20 has been performed (S3: Y), the control unit 100 clears the detection result indicating that the remaining toner amount is small (T-LOW) or absent (T-OUT) for the replaced toner replenishment unit 20. In FIG. 6A, the result of the cartridge replacement reaches T-FULL at the timing T2.

Step S5: the control unit 100 sets a “no replenishment mode” for the developing unit 40. When the “no replenishment mode” is set, the control unit 100 stops replenishment operation by a full detection method using the remaining toner amount detection substrate 6a, and does not execute toner replenishment from the toner replenishment unit 20. As a result, the subsequent image forming operation (printing operation) is performed using only the toner T remaining in the developing container of the developing unit 40. In FIG. 6B, during section R0 (from timing T2 to T3), the toner T in the developing container decreases from D-FULL to D-LOW as it is consumed.

Step S6: the control unit 100 sets “no replenishment dot count” that is a predetermined threshold. The threshold described herein is set as a first threshold. “No replenishment dot count” is a dot count (the number of print data outputs in the image) that can be output during image formation after the control unit 100 sets “no replenishment mode”. The dot count is substantially proportional to the size of a printing region (a region to which the toner T is transferred) on the paper during image formation, a developing concentration (developing bias), and the like. Therefore, the control unit 100 can easily calculate the dot count.

Step S7: the control unit 100 checks whether the dot count output in the “no replenishment mode” exceeds “no replenishment dot count”. In the present example, the dot count threshold is set to correspond to the point when the toner T in the developing container reaches 37 g (D-LOW).

Step S8: when the control unit 100 verifies that the output dot count exceeds “no replenishment dot count” (Step S7: Y), the control unit 100 stops the stirring member 45 of the developing unit 40.

Step S9: next, the control unit 100 sets a “discharge mode” and a “refill mode”. In the toner refresh mode according to the present example, the discharge mode and the refill mode progress simultaneously. In the “discharge mode”, formation of a solid image is instructed. In the “refill mode”, the opening and closing of the toner replenishment shutter 24 is instructed, and determination of the rotating speed of the stirring sheet 23 for toner replenishment is performed. In the present example, a relationship between a toner discharge speed and developing settings is checked by experiment in advance, and by appropriately adjusting the developing contrast, the control unit 100 performs toner discharge of the solid image such that the toner discharge speed is 0.16 g/s. In addition, the control unit 100 sets the rotating speed of the stirring sheet 23 for toner replenishment such that the refill speed is 0.216 g/s. In addition, the discharge is set to continue until the discharge amount of the toner T reaches 20 g.

Step S10: the control unit 100 simultaneously executes the discharge mode (toner discharge operation) and the refill mode (refilling of the toner T). Specifically, the control unit 100 instructs formation of a solid image to intensively consume (discharge) deteriorated toner Td remaining in the developing unit 40 or the toner T having a large particle size. The discharged toner T is transferred from the photosensitive drum 63 to the intermediate transfer belt 5a, and is recovered to the waste toner container by the belt cleaning member 5e.

Here, the reason why the toner T having a large particle size is consumed will be described. For example, in a single component contact developing system, in general, the toner T having a small particle size is likely to be developed, and the toner T having a large particle size is not likely to be developed. As a result, the large particle size toner is likely to remain in the developing device. In addition, in the developing device, the shape of the toner T, the attachment state of an external additive on the toner surface, and the like change due to use over time, and toner T that cannot retain appropriate charge is also present. These toners T are also likely to remain in the developing device. Accordingly, in the developing device where the lifetime increases while repeating additional replenishment, a ratio of the toner T having a large particle size or the toner T in which appropriate charge cannot be retained increases. As a result, various image defects such as a decrease in density or fogging may occur.

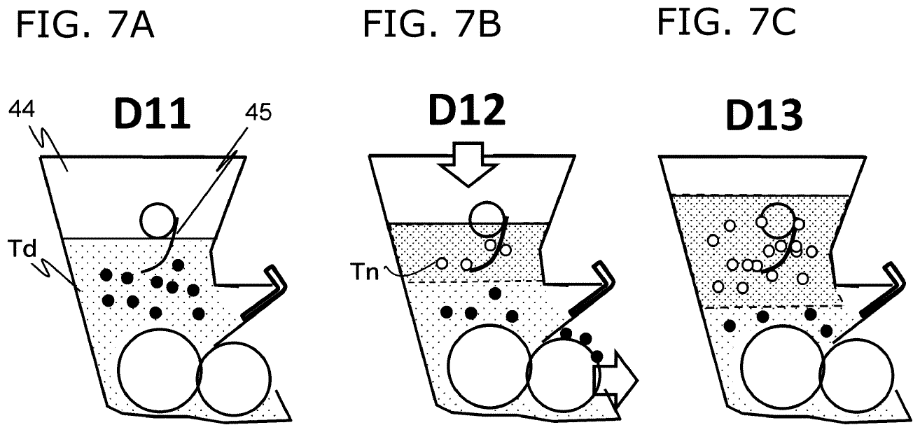

FIGS. 7A to 7C schematically illustrate a state of circulation in the developing container. At the start of S10, the remaining toner amount is 37 g, which corresponds to the TONER-LOW state (D11 in FIG. 7A). In each drawing, black circles indicate deteriorated toner Td, and white circles indicate newly replenished toner Tn. At this time, the stirring member 45 in the developing unit 40 is stopped. Therefore, even when toner Tn is replenished as shown in state D12 in FIG. 7B, the newly replenished toner Tn and the remaining toner Td are unlikely to mix, and vertical circulation substantially does not occur. Therefore, during the discharge, the remaining toner Td is mainly discharged. In addition, since new toner Tn is filled from above in the gravity direction in a larger amount than the discharged toner T, the height of the level of the entire toner T does not decrease. Accordingly, in the present example, the refill can be executed while executing the discharge mode (D13 of FIG. 6B and D13 of FIG. 7C).

Accordingly, in Example 1, the time required for the toner refresh mode can be reduced compared to a case in which discharge and replenishment are executed separately. Specifically, as shown in Table 2, the time of the toner refresh mode is 120 seconds. This time corresponds to a section R1 (timing T3 to timing T4) in FIG. 6A. In addition, failure risk of the developing blade 42 and the like, which is a risk that occurs when the remaining toner amount is small, can be reduced. Specifically, while toner T in the developing device is being discharged by forming a solid image, toner T may not be appropriately placed on the developing roller 41, and the developing blade 42 and the developing roller 41 in the developing device may come into direct contact with each other, which may cause a failure. In addition, deteriorated toner T can be discharged without reducing the remaining toner amount in the developing unit 40. Therefore, the discharge mode can be efficiently executed without decreasing discharge efficiency.

Step S11: the control unit 100 determines whether the discharge amount of the toner T exceeds a threshold. When the discharge amount does not exceed the threshold, the control unit 100 determines that the discharge is not completed (S11: N), and continues the toner discharge operation from Step S10. The threshold of the dot count that is a criterion for determining whether the discharge of the toner T is completed may be set in advance based on the discharge amount predicted from a relationship between the dot count number and the consumption amount.

Step S12: on the other hand, when the discharge amount exceeds the threshold (S11: Y), the discharge mode is stopped, and the process proceeds to the next step.

Step S13: next, the control unit 100 drives the stirring member 45 in the developing container.

Step S14: the control unit 100 determines whether toner T in the developing container is full based on the detection signal from the remaining toner amount detection substrate 6a. When the toner amount in the developing device reaches 43 g, the control unit 100 detects that the toner T is full, and refilling is completed (Step S15). The control unit 100 clears all the mode settings (Step S16), and ends the toner refresh mode.

In the refresh mode of the present example, the discharge operation and the replenishment operation are set to start simultaneously and to end simultaneously. In this case, “simultaneous” represents being substantially simultaneous during the control by the control unit 100. However, the present disclosure is not limited to this configuration. For example, although the effect of suppressing the downtime decreases, the discharge mode may start first as long as the stirring member 45 is stopped when the refill mode starts.

Further, in the present example, the stirring member 45 is configured to be stopped throughout the entire refresh mode section (in the present flow, from the start of refilling to the end of the discharge mode). However, the present disclosure is not limited to this configuration. For example, the stirring member 45 may be stopped only in a partial section in the period from the refill start to the end of the discharge mode. In addition, the stirring speed of the stirring member 45 may be set lower than during normal operation only during a partial section in the period from the refill start to the end of the discharge mode.

When stirring is stopped or the stirring speed is reduced in a partial section, the stirring member 45 may be stopped or operated at a reduced speed from the start of refilling until refilling ends. That is, by stopping the stirring member 45 while replenishment operation is being executed, active mixing of the new toner Tn and the deteriorated toner Td can be suppressed, thereby allowing for preferential discharge of the deteriorated toner Td. Even with these configurations, the effect of reducing downtime compared to conventional methods can still be obtained. Note that, when the stirring member 45 is stopped throughout the entire period from refill start to discharge mode end as in Example 1, the newly refilled toner is hardly discharged during the discharge operation. Therefore, the effect of the refresh mode increases.

The evaluation result after printing 18000 sheets in Example 1 is as shown in Table 1, images with low fogging and good density can be maintained, and the time of the toner refresh mode can be reduced.

### Comparative Example 1

Next, Comparative Example 1 will be described. Unless specified otherwise, the configuration is the same as Example 1. In Comparative Example 1, the discharge mode and the refill mode of the toner refresh mode are executed independently. As shown in Table 1, in Comparative Example 1, the stirring member 45 continues to rotate during the toner refresh mode. Therefore, to prevent new toner Tn and deteriorated toner Td from mixing and to prevent new toner Tn from being discharged, it is necessary to execute the discharge mode first and execute refilling after discharge of deteriorated toner Td is completed.

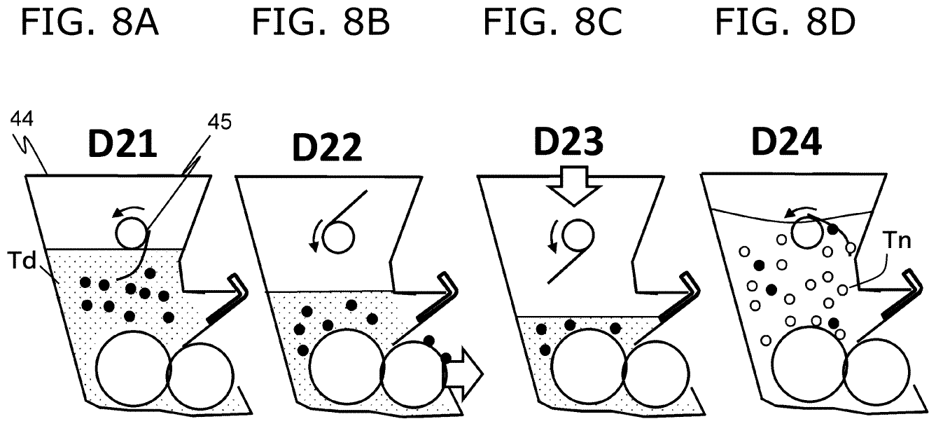

In Comparative Example 1, the transition of the remaining toner amount in the developing container 44 during the toner refresh mode follows the broken line in FIG. 6B. In the schematic diagrams, the transition proceeds from D21 in FIG. 8A to D22 in FIG. 8B to D23 in FIG. 8C, and the remaining toner amount decreases from 37 g to 17 g. As the toner amount decreases, the discharge rate decreases. In addition, a failure risk of the developing blade 42 may occur due to toner depletion on the developing roller 41. This is because the surface of the developing roller 41 and the developing blade 42 come into direct contact with each other, which may cause scratches or other damage to the developing blade 42. Next, the refill mode is executed to refill the toner to 43 g (D24 of FIG. 8D).

As shown in Table 2, the durability test results indicate that the time for the toner refresh mode was 205 seconds (R4 in FIG. 6A), which is much longer than that of Example 1. In addition, in the image evaluation result, streaks occurred in the halftone image. In addition, since the process passed through a state where the remaining toner amount decreases as in D23, the failure risk of the developing blade 42 or the like is present.

### Example 2

In Example 1, the toner refresh mode is executed after stopping the rotation of the stirring member 45 in the developing unit 40. In Example 2, the toner refresh mode is executed using a simpler method without controlling the stirring member 45 in the developing container. The description of the configuration and the control common to those of Example 1 will not be repeated.

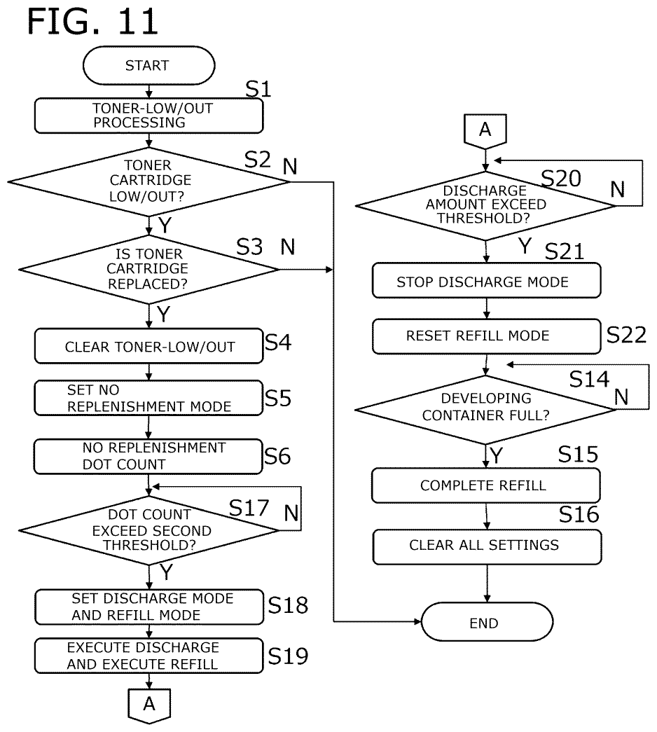

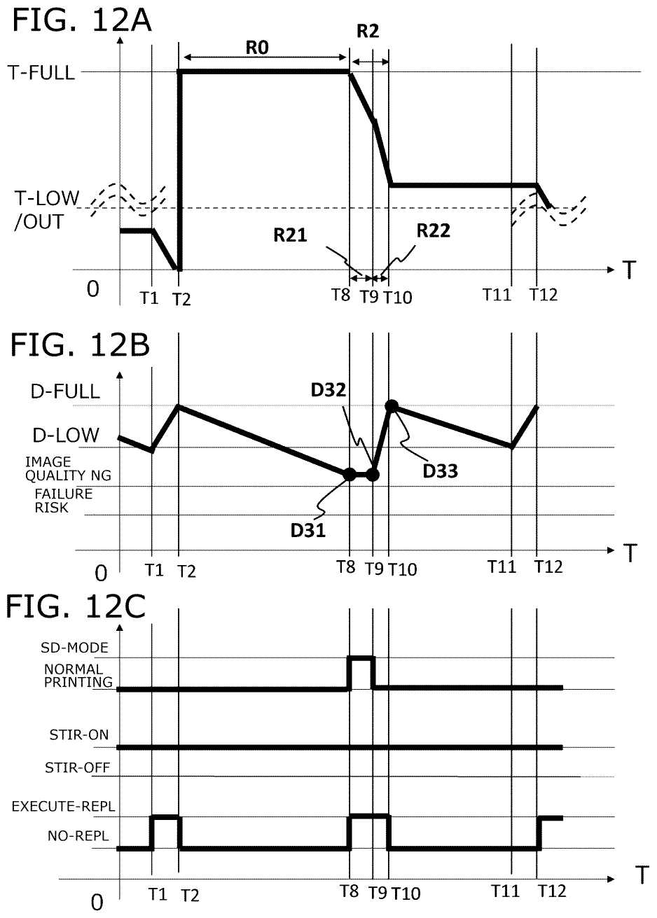

FIG. 11 is a flowchart illustrating a procedure of the toner refresh mode that is executed by the control unit 100 in Example 2. Hereinafter, the procedure of Example 2 will be described. Since the steps of Steps S1 to S6 are the same as those of Example 1, Step 17 and subsequent steps will be described. In addition, FIGS. 12A to 12C are timing charts of Example 2. In FIG. 12C, the meaning of each label attached to the vertical axis is the same as that in FIG. 6C.

Step S17: the control unit 100 checks whether the dot count output in the “no replenishment mode” exceeds “no replenishment dot count”. The no replenishment dot count in this case is set as a second threshold. The second threshold is set to a remaining toner amount at which the level of the deteriorated toner Td remaining in the developing unit 40 is below the rotating stirring member 45 and does not contact the stirring member 45. In Example 2, the dot count threshold is set to correspond to a remaining toner amount of 33 g.

Step S18: when the control unit 100 verifies that the output dot count exceeds “no replenishment dot count” as the second threshold (Step S17: Y), the control unit 100 sets the “discharge mode” and the “refill mode”.

In the present example, the control unit 100 sets the rotating speed of the stirring sheet 23 for toner replenishment so that the refill speed equals the toner T discharge speed (0.16 g/s). In Example 2, the toner discharge speed and the refill speed (replenishment speed) are set to be the same. However, as long as the stirring member 45 and the toner level are in a range where the stirring member and the toner level are not in contact with each other, any of the speeds may be faster than the other speed.

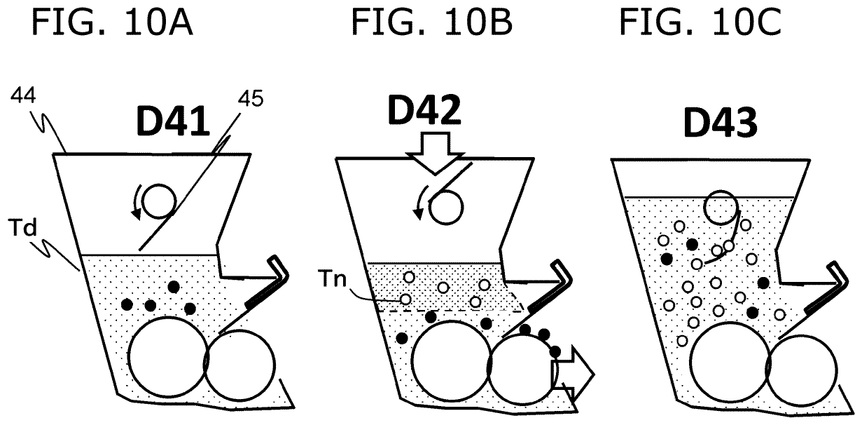

Step S19: the control unit 100 simultaneously starts to execute the discharge mode and the refill mode. FIG. 12B illustrates changes in the remaining toner amount in the developing container, and FIGS. 10A to 10C schematically illustrate circulation within the developing container. The start of S19 is in the state of D41 of FIG. 10A. At this time, the stirring member 45 in the developing container does not come into contact with the level of the deteriorated toner Td.

Even when the replenishment operation is performed in this state, vertical circulation between the newly replenished toner Tn and the deteriorated toner Td hardly occurs (D42 in FIG. 10B). Therefore, the toner T that is used during the discharge is mainly the deteriorated toner Td remaining in the developing device. In addition, as in Example 1, the overall toner level does not decrease. As a result, as illustrated in FIG. 12B, the level does not decrease to a height where a failure risk occurs (timing T8 to timing T9, section R21). Accordingly, in the present example, the refill can be executed while executing the discharge mode.

Step S20: the control unit 100 determines whether the discharge amount of the toner T exceeds a threshold. When the discharge amount does not exceed the threshold, the control unit 100 determines that the discharge has not been completed (S20: N), and continues the toner discharge operation. As in Example 1, the threshold of the dot count that is a criterion for determining whether the discharge of the toner T is completed may be set in advance based on the discharge amount predicted from a relationship between the dot count number and the consumption amount. Here, a discharge amount of 15 g is set as the threshold of the dot count.

Steps S21 to S22: when the discharge amount exceeds the threshold, the discharge mode is stopped, and the refill mode resetting is executed. At this point, since discharge has ended, it is no longer necessary to control the system to prevent contact between the stirring member 45 and the toner surface level. Accordingly, the control unit 100 can increase the replenishment speed (to 0.5 g/s in the present example). The replenishment is executed at timing T9 to timing T10 (section R22) of FIGS. 12A to 12C, that is, for 20 seconds.

Step S14: the subsequent steps is performed as in Example 1. The control unit 100 determines whether the toner T in the developing container is full based on the detection signal of the remaining toner amount detection substrate 6a. When the toner T is full, the process proceeds to Step S15. When the toner amount in the developing device reaches 43 g, the refill is completed (D43 of FIG. 10C). The control unit 100 clears all the mode settings (Step S16), and ends the toner refresh mode.

In the present example, the discharge of the toner T and the refill are set to start simultaneously. However, the present disclosure is not limited to this configuration. For example, although the effect of suppressing downtime is reduced, the discharge mode may start first as long as the stirring member 45 does not contact the toner level when the refill mode begins.

Furthermore, in the present example, the stirring member 45 is configured not to contact the toner surface level throughout the entire period from refill start to discharge mode end. However, the present disclosure is not limited to this example. For example, the stirring member 45 and the toner level may be in contact with each other only in a partial section in the period from the refill start to the end of the discharge mode. However, as in Example 2, when the stirring member 45 and the toner level remain out of contact throughout the entire period from refill start to discharge mode end, newly refilled toner is hardly discharged during the discharge operation. Therefore, the effect of the refresh mode increases.

According to the durability results for Example 2 shown in Table 1, images with reduced fogging and good density can be maintained, and the time of the toner refresh mode can be reduced. In addition, the toner refresh mode can be executed irrespective of the control of the stirring member 45. Therefore, this configuration is simpler than that of Example 1. In addition, when the toner particle size in the developing container after the durability test is measured, the toner particle size is 8.0 μm, and it can be verified that a change in durability is small.

As shown above in Table 2, in Example 2, the toner refresh mode time (R2 in FIG. 12A=110 seconds) is shorter than in Example 1. In addition, the deteriorated toner T can be discharged without reducing the remaining toner amount. Accordingly, the discharge mode can be efficiently executed without reducing the discharge amount.

### Comparative Example 2

In the configuration of Comparative Example 2, the discharge mode and the refill mode are executed simultaneously as in Example 1, and the time of the toner refresh mode can be reduced. However, unlike Example 1 or Example 2, the stirring member 45 penetrates the toner level in the developing container while rotating. Therefore, the deteriorated toner T and the new toner T in the developing device are mixed and circulated in the present configuration.

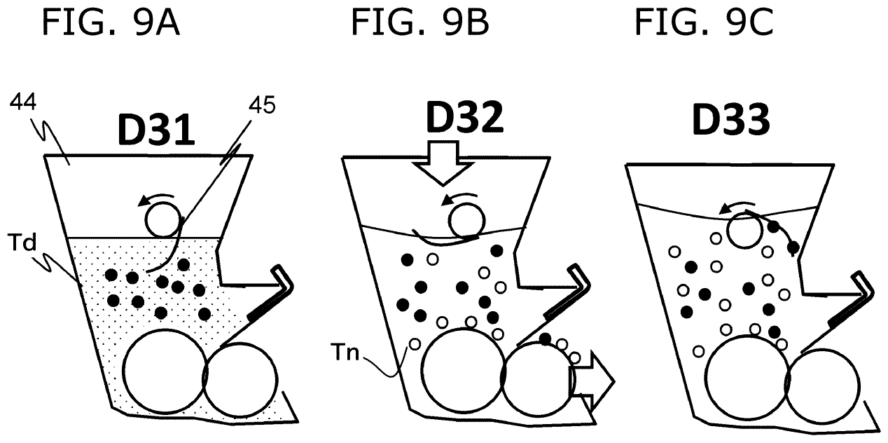

As shown in Table 1, in Comparative Example 2, the stirring member 45 rotates even during the refresh mode (D31 of FIG. 9A). Therefore, the new toner Tn and the deteriorated toner Td are discharged while being mixed with each other. As a result, not only the deteriorated toner Td but also the new toner Tn is discharged (D32 of FIG. 9B).

In Comparative Example 2, the transition of the remaining toner amount in the developing container 44 during refresh mode follows the solid line from D11 to D12 to D13 in FIG. 6B, as in Example 1. In the schematic diagrams, the transition proceeds from D31 (FIG. 9A) to D32 (FIG. 9B) to D33 (FIG. 9C). Here, in Comparative Example 2, the discharge and the refill are simultaneously executed. Therefore, the toner refresh mode time is R11=120 seconds, which is shorter than Comparative Example 1 as with Example 1. However, the discharged toner T includes new toner Tn. In addition, the new toner Tn tends to have a higher charge compared to the deteriorated toner Td, and is thus preferentially supplied to the developing roller 41 and discharged due to mirror image force or the like. Therefore, in Comparative Example 2, a large amount of the new toner Tn is discharged, and the toner refresh in the developing container is not sufficient.

Accordingly, as shown in Table 2, as a result of the durability evaluation, fogging deterioration and a decrease in density were observed. In addition, the average toner particle size in the developing container was 9.0 μm, and a large change was observed.

### Example 3

Example 3 has the same configuration as Example 2, but features a distinctive method for discharging toner T in discharge mode. As a result, although the configuration is the same as that of Example 2, a large amount of the deteriorated toner Td can be efficiently discharged.

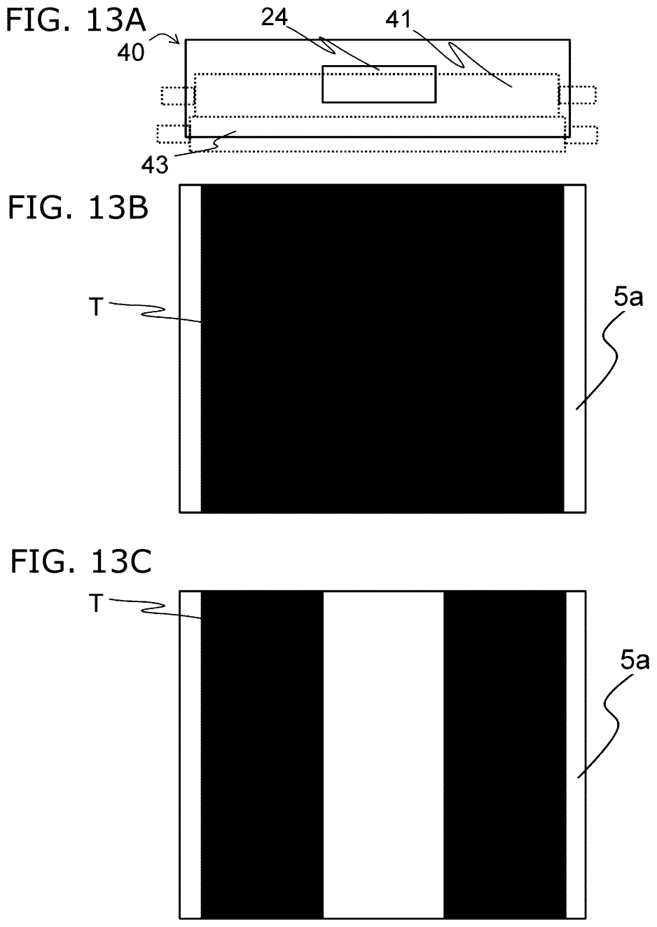

FIG. 13A is a diagram illustrating a lower side of the developing container 44 in the gravity direction when seen from a direction of an arrow 70 in FIG. 2. In the drawing, the developing roller 41 and the supply roller 43 are illustrated in a state viewed through other members, and a position where the toner replenishment shutter 24 is projected downward in the gravity direction is illustrated.

Example 3 is characterized by increasing the toner T discharge amount at positions in the longitudinal direction of the supply roller 43 that are distant from the replenishment opening (i.e., the position of the toner replenishment shutter 24) during discharge mode. In the present example, a replenishment port is positioned at the center of the developing unit 40. Therefore, the discharge amount is increased at both end portions of the supply roller 43 in the longitudinal direction.

FIGS. 13B and 13C are diagrams illustrating the state of the toner discharge in the present example. When the toner discharge starts in Step S19 of the flow of FIG. 11, the control unit 100 prints solid black on a front surface of the intermediate transfer belt 5a and discharges the toner T as in FIG. 13B.

When the control unit 100 determines from dot count measurement that the discharge amount exceeds 15 g, a solid black image is printed only at both end portions of the supply roller 43 that are distant from the toner replenishment shutter 24, as shown in FIG. 13C. This increases the toner discharge amount at both end portions. This is because the new toner Tn is replenished to the toner surface from the center of the upper part of the replenishment port, so the new toner Tn reaches the supply roller 43 more quickly at the center portion. When 15 g of the toner T is consumed, the new toner Tn reaches the center portion of the supply roller. At both end portions, the deteriorated toner Td still remains in the periphery of the supply roller. Therefore, by discharging toner T only at both end portions during simultaneous discharge and replenishment, a larger amount of deteriorated toner Td can be discharged with minimal consumption of new toner T. The remaining toner amount transition is the same as that of Example 2 until the section R2 of FIG. 12A ends, and subsequently, an end portion discharge operation is executed for 20 seconds.

As shown in Table 2, in Example 3, the image quality such as the density or fogging can be favorably maintained while reducing the time of the toner refresh mode. The toner particle size in the developing container was 7.7 μm, and the change in particle size was smaller than that of Example 1 or 2.

### Comparative Example 3

Comparative Example 3 shows the results of the durability test performed without executing the toner refresh mode at all. As shown in Table 2, image quality deterioration such as a decrease in density or fogging was significant. In addition, the average particle size of the toner T was much larger than that in the initial toner state. It can be seen from the above result that the toner refresh mode largely contributes to image quality stabilization.

As described above, according to the examples of the present disclosure, the toner T in the developing container can be efficiently refreshed, and high image quality can be maintained throughout durability testing while reducing the risk of failure during toner discharge.

As described above, according to the present disclosure, it is possible to provide a technique for efficiently refreshing toner remaining in a developing device of an image forming apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-061928, filed Apr. 3, 2025, which is hereby incorporated by reference herein in its entirety.

What is claimed is:

1. An image forming apparatus capable of executing an image forming operation to form an image on a recording material, the image forming apparatus comprising:
an image carrier having a surface on which an electrostatic latent image is formed;
a developing unit including:
a developing container configured to store developer,
a rotatable stirring member disposed in the developing container and configured to stir the developer, and
a developer carrier configured to supply the developer in the developing container to the electrostatic latent image to form an image;
a replenishment unit disposed above the developing unit in a gravity direction, the replenishment unit including a replenishment container configured to store the developer and communicate with the developing container through a replenishment port; and
a control unit configured to control rotation of the stirring member,
wherein the control unit is configured to:
(i) control execution of a refresh mode including:
a discharge operation to discharge the developer in the developing container to the image carrier, and
a replenishment operation to replenish the developing container with the developer from the replenishment container;
(ii) when executing the refresh mode, control starting of the replenishment operation before the discharge operation ends; and
(iii) after starting the refresh mode, in at least a part of a section until the refresh mode ends, control the stirring member such that a rotating speed of the stirring member is slower than a rotating speed during the image forming operation, or such that the stirring member is stopped.

2. The image forming apparatus according to claim 1, wherein the control unit is configured to, in at least a section after the replenishment operation starts, control the stirring member such that the rotating speed of the stirring member is slower than a rotating speed during the image forming operation, or such that the stirring member is stopped.

3. The image forming apparatus according to claim 1, wherein the control unit is configured to, in at least a section until the discharge operation ends, control the stirring member such that the rotating speed of the stirring member is slower than a rotating speed during the image forming operation, or such that the stirring member is stopped.

4. An image forming apparatus capable of executing an image forming operation to form an image on a recording material, the image forming apparatus comprising:
an image carrier having a surface on which an electrostatic latent image is formed;
a developing unit including:
a developing container configured to store developer,
a rotatable stirring member disposed in the developing container and configured to stir the developer, and
a developer carrier configured to supply the developer in the developing container to the electrostatic latent image to form an image;
a replenishment unit disposed above the developing unit in a gravity direction, the replenishment unit including a replenishment container configured to store the developer and communicate with the developing container through a replenishment port; and
a control unit configured to control the stirring member, wherein the control unit is configured to:
(i) control execution of a refresh mode including:
a discharge operation to discharge the developer in the developing container to the image carrier, and
a replenishment operation to replenish the developing container with the developer from the replenishment container;
(ii) when executing the refresh mode, control starting of the replenishment operation before the discharge operation ends; and
(iii) after starting the refresh mode, in at least a part of a section until the refresh mode ends, control discharge of the developer such that the stirring member in the developing container does not come into contact with the developer.

5. The image forming apparatus according to claim 4, wherein the control unit is configured to control a discharge speed in the discharge operation and a replenishment speed in the replenishment operation such that the stirring member does not come into contact with a level of the developer during the refresh mode.

6. The image forming apparatus according to claim 5, wherein the control unit is configured to control the replenishment speed in the replenishment operation to be increased after the discharge operation ends.

7. The image forming apparatus according to claim 1, further comprising a replenishment control member configured to control replenishment of the developing container with the developer from the replenishment container,
wherein the control unit is configured to control the replenishment control member such that the discharge operation and the replenishment operation start and end simultaneously.

8. The image forming apparatus according to claim 7, wherein the replenishment control member is configured to change a replenishment speed of the developer by changing the rotating speed of the stirring member.

9. The image forming apparatus according to claim 1, wherein
the developing unit further includes a supply member configured to supply the developer to the developer carrier;
the supply member has a longitudinal direction, and the replenishment port through which the replenishment container and the developing container communicate with each other is disposed above the supply member in the gravity direction; and
during the discharge operation, the control unit is configured to control discharge such that a discharge amount of the developer increases as a distance between a position of the supply member and a position at which the replenishment port is projected in the gravity direction increases.

10. The image forming apparatus according to claim 1, wherein the replenishment unit is a cartridge attachable to the developing unit.

11. The image forming apparatus according to claim 4, further comprising a replenishment control member configured to control replenishment of the developing container with the developer from the replenishment container,
wherein the control unit is configured to control the replenishment control member such that the discharge operation and the replenishment operation start and end simultaneously.

12. The image forming apparatus according to claim 11, wherein the replenishment control member is configured to change a replenishment speed of the developer by changing the rotating speed of the stirring member.

13. The image forming apparatus according to claim 4, wherein:
the developing unit further includes a supply member configured to supply the developer to the developer carrier;
the supply member has a longitudinal direction, and the replenishment port through which the replenishment container and the developing container communicate with each other is disposed above the supply member in the gravity direction; and
during the discharge operation, the control unit is configured to control discharge such that a discharge amount of the developer increases as a distance between a position of the supply member and a position at which the replenishment port is projected in the gravity direction increases.

14. The image forming apparatus according to claim 4, wherein the replenishment unit is a cartridge attachable to the developing unit.
